(19) United States
(12) Patent Application Publication
(10) Pub. No.: US 2013/0034694 A1
(43) Pub. Date: Feb. 7, 2013

(54) TRANSLUCENT FILM FOR PROTECTING ROUGH SURFACES

(71) Applicants: Michael H. Kim, Woodbury, MN (US); Charlie C. Ho, Woodbury, MN (US)

(72) Inventors: Michael H. Kim, Woodbury, MN (US); Charlie C. Ho, Woodbury, MN (US)

(21) Appl. No.: 13/582,058

(22) PCT Filed: Mar. 1, 2011
(86) PCT No.: PCT/US11/26572

§ 371 Date: Sep. 27, 2012

Related U.S. Application Data
(60) Provisional application No. 61/309,277, filed on Mar. 1, 2010.

(51) Int. Cl. B32B 3/30

(52) U.S. Cl. 428/142; 428/141

(57) ABSTRACT

A translucent surface protection film suitable for protecting relatively rough surfaces such as, for example, the painted surfaces often found on architectural structures like doors, walls, etc. The translucent surface protection film comprises a polymeric layer backed by an adhesive layer comprising a pressure sensitive adhesive. The adhesive layer defines a major surface of the film, with another major surface of the film having a surface texture that exhibits a 60 degree Gloss Level of less than or equal to 15. The rheological properties of the adhesive allow the adhesive layer to achieve a wet out of at least 70%, when the adhesive layer is applied onto a surface having a surface roughness with a peak count (PC) of at least 250 peaks/meter.

The present invention relates to translucent adhesive-backed films for protecting surfaces, in particular, to such films that are suitable for protecting surfaces that have relatively rough textures, more particularly, to such films that are suitable for being adhered so as to protect relatively rough painted surfaces, and to the combination of such films and substrates with such rough surfaces.

### BACKGROUND

Adhesive-backed transparent films for protecting exterior painted surfaces of automobile body parts (e.g., the leading edge of hoods, grills, etc.) are well known. The exterior painted surfaces of most automobile bodies are very smooth and exhibit high gloss levels. For example, the painted surfaces of automobile body parts typically exhibit high gloss levels of at least a 85 gloss at 60 degrees. The known paint protection films used to protect such surfaces are designed to be highly transparent to light (i.e., having over 90% visible light transmission) and to have a high gloss top surface (e.g., at least about 85 gloss at 60 degrees) so as to be barely visible on the surface of the automobile.

Adhesive-backed surface protection films are not known for use in protecting rough surfaces such as those often found on architectural structures like, for example, the painted surfaces of doors and walls.

### SUMMARY OF THE INVENTION

The present inventors discovered that conventional transparent paint protection films, like those typically used to protect the painted surface of automobile body parts (e.g., hoods, etc.), are not suitable for rough surfaces. The pressure sensitive adhesives typically used to adhere such conventional transparent paint protection films were found to be too thin and too firm to adequately wet out and adhere to such rough surfaces. By adjusting the rheology of the adhesive, the resulting adhesive surface can more easily wet out onto rougher surfaces to much higher degrees.

In one aspect of the present invention, a translucent surface protection film is provided that is suitable for protecting relatively rough surfaces such as, for example, the painted surfaces often found on architectural structures like doors, walls, etc. The translucent surface protection film has opposite major surfaces and comprises a polymeric layer backed by an adhesive layer comprising an adhesive material. The adhesive comprises a pressure sensitive adhesive. The adhesive layer defines one of the major surfaces of the film, with the other major surface of the film having a surface texture that exhibits a 60 degree Gloss Level of less than or equal to about 15. The adhesive material has rheological properties that allow the adhesive to achieve a wet out of at least about 70%, when the adhesive layer is applied onto a surface having a surface roughness with a peak count (PC) of at least 250 peaks/meter. Optionally, the surface protection film can further comprise a clearcoat layer that is at least partially crosslinked and defines the other major surface of the film, which has the specified surface texture.

It can also be desirable for the adhesive of the present inventive surface protection film to have rheological properties that allow the adhesive to achieve such wet out, when applied onto such rough surfaces having an average surface roughness (Ra) of less than about 13 μm, as measured using the surface profile measurement technique disclosed herein. In addition, it can be desirable for the adhesive of the present inventive surface protection film to have rheological properties that allow the adhesive to achieve such wet out, when applied onto such a rough surface having a maximum peak to valley height (Rt) of less than about 200 μm, as measured using the surface profile measurement technique disclosed herein. It can further be desirable for the adhesive to have rheological properties that allow the adhesive to achieve such wet out, when applied onto such a rough surface having a combination of two or more of a surface roughness with a peak count (PC) of at least 250 peaks/meter, an average surface roughness (Ra) of less than about 13 μm, and/or a maximum peak to valley height (Rt) of less than about 200 μm.

The rheological properties exhibited by the adhesive include a Loss Tangent Delta value of (a) greater than or equal to about 0.65, when measured by a dynamic shear modulus at 1 radian/sec and 23 degrees C., (b) greater than or equal to about 0.40, when measured by a dynamic shear modulus at 0.1 radian/sec and 23 degrees C., or a combination of both (a) and (b). The Loss Tangent Delta is the ratio of the loss shear modulus (G″) over the storage shear modulus (G′) of the adhesive material. The rheological properties exhibited by the adhesive can also include a stress relaxation ratio, according to the equation: G′(t₂)/G′(t₁), of (a) less than or equal to about 0.1, when t₂ is 500 seconds and t₁ is 0.1 seconds, (b) less than or equal to 0.25, when t₂ is 500 seconds and t₁ is 1.0 seconds, or (c) a combination of both (a) and (b). Stress relaxation measures how quickly a polymer can relieve stress under a constant strain.

In another aspect of the present invention, a combination is provided that comprises a substrate and any surface protection film according to the present invention. The substrate comprises a surface having a surface roughness with a peak count (PC), as measured using the surface profile measurement technique disclosed herein, of at least 250 peaks/meter. The adhesive layer is adhesively bonded to the substrate such that the surface protection film covers at least a portion, most (i.e., greater than 50%) or substantially all of the rough surface.

The present invention provides a surface protection film that can protect relatively rough surfaces such as, for example, those often found on architectural structures like doors, walls, etc. The present surface protection film can achieve relatively high degrees of wet out onto such rough surfaces, compared to the degree of wet out obtained on rough surfaces using convention transparent paint protection film.

These and other advantages of the present invention can be found in the structural features shown and described in the drawings and detailed description of this invention. It is to be understood, however, that the drawings and description are for illustration purposes only and should not be read in a manner that would unduly limit the scope of this invention.

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

In the accompanying drawings:

FIG. 1 is a cross sectional perspective view of one embodiment of a translucent surface protection film, in accordance with the present invention, in combination with an architectural structure;

FIG. 2 is a cross sectional edge view of the surface protection film of FIG. 1 adhered to the rough surface of a substrate; and

FIG. 3 is an enlarged cross sectional edge view of the encircled area A of FIG. 2.

### DETAILED DESCRIPTION OF CERTAIN EMBODIMENTS

In describing preferred embodiments of the invention, specific terminology is used for the sake of clarity. The invention, however, is not intended to be limited to the specific terms so selected, and each term so selected includes all technical equivalents that operate similarly.

As used in this specification and the appended claims, the terms set forth below will have the meanings as defined:

Unless otherwise indicated, use of the term “about” to modify, for example, numbers expressing feature sizes, amounts, and physical properties used in the specification and claims is to be understood as indicating that such modified numerical parameters are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used herein, “a,” “an,” “the,” “at least one,” and “one or more” are used interchangeably; the term “and/or” means one or all of the listed elements or a combination of any two or more of the listed elements; and the term “or” is generally employed in its sense including “and/or” unless the content clearly dictates otherwise.

The terms “comprises” and variations thereof do not have a limiting meaning where these terms appear in the description and claims.

The term “polymer” is synonymous with the term “polymeric” and will be understood to include polymers, copolymers (e.g., polymers formed using two or more different monomers), oligomers and combinations thereof, as well as polymers, oligomers, or copolymers that can be formed in a miscible blend.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, a “high traffic surface” refers to any surface with at least the potential of experiencing contact with the footwear (e.g., shoes, boots, etc.), clothing (e.g., gloves, jackets, etc.) or body parts (e.g., hair/fur, skin, etc.) of a large number of people or animals over a relatively short period of time (e.g., hundreds of such contacts each month, week, day or even each hour).

As used herein, references to the present inventive protection film being “translucent” refer to the underlying painted or unpainted rough surface being visible through the surface protection film. The degree to which the underlying rough surface is visible through the film can be adjusted as desired by choosing a corresponding texture for the exposed surface of the film and may also be further adjusted, for example by pigmenting the film.

As used herein, the term “wet out” refers to the amount of surface contact between an adhesive and a surface (e.g., a rough surface on an architectural structure). Generally, the greater the wet out, the better the adhesive bond to the surface, because a larger area of the adhesive is in contact with the surface. For applications with clear substrates/films, greater wet out can also result in fewer visible voids in the adhesive or air bubbles, which can result in a more pleasing aesthetic appearance.

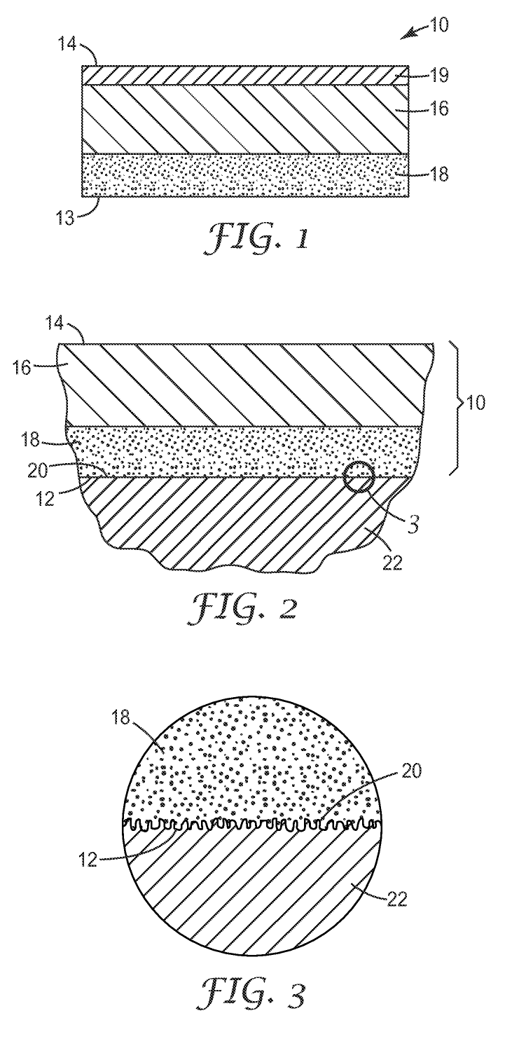

In the practice of the present invention, a translucent surface protection film is suitable for protecting relatively rough surfaces such as, for example, those often found on architectural structures. Referring to FIG. 1, one embodiment of such a translucent surface protection film 10 has opposite major surfaces 12 and 14 and comprises a polymeric layer 16 backed by an adhesive layer 18 comprising an adhesive material. The adhesive layer 18 is, preferably, a layer of pressure sensitive adhesive such as, for example, an acrylic pressure sensitive adhesive. The adhesive layer 18 defines one of the major surfaces 12 of the film 10.

The polymeric layer 16 can be made of any suitable polymeric material. The polymeric layer 16 may comprise, for example, one or more polymeric materials selected from the following group of polymer materials: polyurethanes, polyvinylchlorides, polyvinyl acetates, ethylene-vinyl acetate copolymers, ethylene-acrylic acid copolymers, ethylene-methacrylic acid copolymers, metal ions neutralized ethylene-acrylic acid copolymers, metal ions neutralized ethylene-methacrylic acid copolymers, polyesters, acrylic polymers, and combinations thereof. Preferably, the polymeric layer comprises a thermoplastic polyurethane (TPU).

Referring to FIGS. 2 and 3, the adhesive layer 18 is adhesively bonded to a rough surface 20 of a substrate 22. The adhesive layer 18 is adhesively bonded to the substrate 22 such that the surface protection film 10 covers at least a portion, most (i.e., greater than 50%) or all of the rough surface 20. The substrate 22 can be any structure that includes a rough surface. The rough surface 20 can be painted or unpainted. The substrate 22 can be made of any suitable material such as, for example, wood, metal (e.g., stainless steel) or plastic. Such substrates can be selected from, and the surface protection film dimensioned in the shape of, for example, rough surfaces of architectural structures such as a door (e.g., the surface protection film can be dimensioned to cover the entire door or so as to function as a kick plate for the door), wall, railings, floor trim, wall trim, and the vertical portion of a step or any other structure that has a rough surface and, preferably, a high traffic rough surface. The surfaces of such architectural structures are often painted, for example, with nap rollers, including deep nap rollers, which result in the painted surface having a relatively rough texture.

The present inventors discovered that conventional transparent paint protection films, like those typically used to protect the painted surface of automobile body parts (e.g., hoods, etc.), are not suitable for such rough surfaces. The pressure sensitive adhesives typically used to back such convention transparent paint protection films were found to be too thin and too firm to wet out and adhere to such rough surfaces to an adequate degree (e.g., at least 70% up to at least 90% and more). To address this problem, the adhesive caliper (i.e., thickness) was increased (e.g., from about 51 microns to at least 76 microns) and the adhesive firmness was reduced by adjusting the rheology of the adhesive so as to produce a softer (i.e., lower molecular weight and intrinsic viscosity) adhesive. The resulting adhesive surface can more easily wet out onto rougher surfaces.

The adhesive material for the adhesive layer 18 is formulated, using conventional techniques (e.g., by using relatively low molecular weight resins, lower amounts of a crosslinker, and/or less reactive crosslinkers), so as to exhibit rheological properties that allow the adhesive to achieve a wet out of at least about 70%, 75%, 80%, or 85%, and preferably at least about 90%, 95% or 99%, when the adhesive layer 18 is applied onto the rough surface 20. The surface 20 exhibits a surface roughness with a peak count (PC) of at least 250 peaks/meter, at least 300 peaks/meter, at least 350 peaks/meter, or at least 400 peaks/meter, as measured using the surface profile measurement technique disclosed herein.

It is desirable for the adhesive layer 18 to have a thickness that is at least about 76 μm (3.0 mils) and preferably at least about 89 μm (3.5 mils) or at least about 102 μm (4.0 mils). The thickness of the adhesive layer of a conventional paint replacement film, used to protect painted body parts of an automobile, is typically about 51 μm (2 mils) thick. By increasing the thickness of the adhesive layer, in addition to the rheological changes, the adhesive layer is able to more easily conform to and wet out onto such rough surfaces as disclosed herein.

The rheological properties exhibited by the adhesive include a Loss Tangent Delta value of (a) greater than or equal to about 0.65 or about 0.70, when measured by a dynamic shear modulus at 1 radian/sec and 23 degrees C., (b) greater than or equal to about 0.40 or about 0.50, when measured by a dynamic shear modulus at 0.1 radian/sec and 23 degrees C., or a combination of both (a) and (b). The Loss Tangent Delta is the ratio of the loss shear modulus (G″) over the storage shear modulus (G′) of the adhesive material. The rheological properties exhibited by the adhesive can also include a stress relaxation ratio, according to the equation: G′(t₂)/G′(t₁), of (a) less than or equal to about 0.1, when t₂ is 500 seconds and t₁ is 0.1 seconds, (b) less than or equal to 0.25, when t₂ is 500 seconds and t₁ is 1.0 seconds, or (c) a combination of both (a) and (b). Stress relaxation measures how quickly a polymer can relieve stress under a constant strain.

It can be desirable for the present inventive surface protection film to be used with such rough surfaces that have a surface roughness peak count of up to about 950 peaks/meter (e.g., in the range of from about 250 peaks/meter to about 950 peaks/meter). It can also be desirable for the adhesive of the present inventive surface protection film to have rheological properties that allow the adhesive to achieve such wet out percentages when applied onto such rough surfaces having an average surface roughness (Ra) of less than about 13 μm, about 12.5 μm, about 12 μm, about 11.5 μm, about 11 μm, or about 10.5 μm, as measured using the surface profile measurement technique disclosed herein. It can further be desirable for the adhesive of the present inventive surface protection film to have rheological properties that allow the adhesive to achieve such wet out percentages when applied onto such a rough surface having a maximum peak to valley height (Rt) of less than about 200 μm, about 170 μm, about 160 μm, about 150 μm, about 140 μm, or about 130 μm, as measured using the surface profile measurement technique disclosed herein.

The present surface protection film has also been found to be an effective way to extend the time between painting, replacing or otherwise refurbishing rough surfaces, like those found on architectural structures. It has been found to be relatively easy to compromise the high gloss surface appearance of conventional paint protection film (e.g., due to the film surface being scratched or otherwise marred). By texturing the surface 14 (see FIG. 1), the appearance of the present inventive protection film can be made less likely to be compromised when the surface 14 sustains scratches or other marring. Desirable results have been obtained, when the major surface 14 of the film 10 has a surface texture that exhibits a 60 degree Gloss Level of less than or equal to about 15, 14, 13, 12, or 11, and preferably less than or equal to about 10, 9, 8, 7, or 6, as measured using conventional surface gloss measuring techniques such as, for example, by using a Byk-Gardner gloss meter, from Columbia, Md., USA. Optionally, the surface protection film 10 can further comprise a clearcoat layer 19 that is at least partially crosslinked. When it is included, the clearcoat layer 19 defines the other major surface 14 of the film 10 and includes the specified surface texture. Preferably, the clearcoat layer comprises an at least partially crosslinked polyurethane material. The at least partially crosslinked polyurethane can comprise, for example, at least one of a polyester-based polyurethane or a polycarbonate-based polyurethane.

The following Examples have been selected merely to further illustrate features, advantages, and other details of the invention. It is to be expressly understood, however, that while the Examples serve this purpose, the particular ingredients and amounts used as well as other conditions and details are not to be construed in a manner that would unduly limit the scope of this invention.

### Test Methods

### Dynamic Shear Modulus Measurement

The loss tangent, shear storage modulus and shear loss modulus of adhesives were measured using an ARES Rheometer from TA Instruments, New Castle, Del., USA. Adhesive samples were loaded between two 25 mm diameter roundplates spaced apart in parallel by a 1.0 mm gap and tested for their dynamic shear modulus, measured as a function of temperature between 20° C. and 80° C. and at a shear rate of 1.0 radian per second. The loss tangent (Tan Delta) at 23° C. was reported.

### Surface Profile Measurements

The surface topography of the film samples were measured using a Dektak 8 Stylus Profilometer (from Veeco Inc, Plainview, N.Y., USA) with a 2.5 micron radius tip and a 3 mg force. Analysis was performed with Vision software (from Veeco Inc). Peak count (PC) was reported as the number of peaks per unit length. A peak is defined as a height of the profile greater than a threshold value above the mean line. A peak count that is high is one where the surface “goes up and down” a lot more in a unit area. This equipment was used to also measure the average roughness (Ra) and the maximum peak-to-valley height (Rt).

### Stress Relaxation Test Method

Stress relaxation was measured using an ARES Rheometer from TA Instruments, New Castle, Del., USA. Adhesive samples were loaded in between two 25 mm diameter round parallel plates spaced apart by 1.0 mm gap. The shear stress relaxation was measured at 23 degrees C. with 3% strain up to 500 seconds. The shear modulus ratio of G(t₁)/G(t₂) was reported.

### EXAMPLES

### Example 1

A clearcoat material was made by adding 0.35 grams of Tinuvin-123 (from Ciba Chemicals, Tarrytown, N.Y.), 0.05 grams AMP-95 (Dow Chemical, Midland, Mich.), 0.20 grams of Triton GR-7M (from Dow Chemical, Midland, Mich.), 8.5 grams of butyl carbitol (from Eastman Chemical Company, Kingsport, Tenn.), and 1.16 grams of Uvinul N3039 (from BASF) into 89.71 grams of Neorez-933 (from Neoresins, Inc, Wilmington, Mass.). De-ionized water was added, at approximately 8% by weight, to keep the viscosity in between 70 cps and 200 cps. 1.78 grams of Neocryl CX-100 (from Neoresins, Inc, Wilmington, Mass.) was added to the clear coating solution prior to coating and agitated for 5 minutes.

The clear coat solution was coated to a wet thickness of 75 microns on a low gloss liner (which provides 60° gloss level of approximately 6). The resulting clearcoat was then heat cured to a dry thickness of about 12 microns. The 60° gloss reading was about 6.4. While on its low gloss liner, the exposed surface of the cured clearcoat was thermally laminated to a 152 μm (6 mils) thick layer of extruded Tecoflex CLA-93A-V thermoplastic polyurethane (from Lubrizol, Wickliffe, Ohio) on a plain polyester carrier web at 250° F. The lamination line speed was 10 feet per minute. The polyester carrier web on the thermoplastic polyurethane was removed.

A pressure sensitive adhesive composition was wet coated to a thickness of about 300 microns on a paper release liner. The adhesive composition was formulated by mixing together a weight ratio of 90% isooctyl acrylate, 10% acrylic acid and 1.25% of the cross-linker 1,1′-(1,3-Phenylenedicarbonyl)bis[2-methylaziridine] (IUPAC), which was pre-thinned with 20% butyl acetate. IUPAC is sometimes referred to generically as polyaziridine. The wet layer adhesive was cured in jet air ovens for 1 minute at 125° F. followed by 1 minute at 150° F. and then 1 minute at 225° F. The cured adhesive had an intrinsic viscosity of about 0.8 and a thickness of about 50 microns. The layer of cured pressure sensitive adhesive was thermally laminated to the exposed surface of the thermoplastic polyurethane layer at a temperature of 200° F. and a lamination line speed of about 10 feet per minute.

### Example 2

The same film as in Example 1 was used in this example, except the adhesive composition was pre-thinned with 10% by weight of isopropyl alcohol and 20% by weight of propylene glycol methyl ether acetate. The pre-thinned adhesive was mixed with 0.875% by weightof the cross-linker 1,1′-(1,3-Phenylenedicarbonyl)bis[2-methylaziridine] (IUPAC) and coated to a wet thickness of 500 microns on a paper release liner. The wet adhesive layer was then cured in jet air ovens for 1.2 minutes at 100° F. followed by 1.2 minutes at 150° F. and then 1.2 minutes in 225° F. The thickness of the cured adhesive was about 88 microns. The layer of cured pressure sensitive adhesive was then thermally laminated to the exposed surface of a thermoplastic polyurethane layer, like that produced in Example 1, at a temperature of 250° F. and a lamination line speed was about 10 feet per minute.

### Comparative Example 1

A pressure sensitive adhesive composition was wet coated to a thickness of 450 microns on a paper release liner. The adhesive composition was formulated by mixing together a weight ratio of 90% isooctyl acrylate, 10% acrylic acid and 0.25% of the cross-linker 1,1′-(1,3-Phenylenedicarbonyl)bis[2-methylaziridine] (IUPAC). The wet layer adhesive was cured in jet air ovens for 1 minute at 150° F. followed by 2 minutes at 200° F. The cured adhesive had an intrinsic viscosity of about 1.8 and a thickness of 50 microns. The resulting layer of cured pressure sensitive adhesive was then thermally laminated to the exposed surface of a thermoplastic polyurethane layer, like that produced in Example 1, at a temperature of 200° F. and a lamination rate of 10 feet per minute.

### Comparative Example 2

The same adhesive used in Comparative Example 1, except the adhesive thickness was 100 microns. The doubled adhesive thickness was achieved by laminating two 50 micron adhesive layers together. The double layer of cured pressure sensitive adhesive was then thermally laminated to the exposed surface of a thermoplastic polyurethane layer, like that produced in Example 1, at a temperature of 200° F. and a lamination rate of 10 feet per minute.

The degree of wet out obtained by adhering the adhesive-backed film of Example 2 onto a variety of rough surfaces, having varying degrees of roughness, was greater than that obtained with the adhesive-backed film of Example 1. The adhesive-backed film of Comparative Example 1 had the worst degree of wet out. By doubling the thickness of the adhesive, the adhesive-backed film of Comparative Example 2 exhibited improved wet out relative to Comparative Example 1, but the degree of wet out was only marginally acceptable for the lower end of the roughness scale for the rough surfaces according to the present invention.

This invention may take on various modifications and alterations without departing from its spirit and scope. Accordingly, this invention is not limited to the above-described but is to be controlled by the limitations set forth in the following claims and any equivalents thereof.

This invention may be suitably practiced in the absence of any element not specifically disclosed herein.

All patents and patent applications cited above, including those in the Background section, are incorporated by reference into this document in total.

1. A translucent surface protection film having opposite major surfaces and comprising a polymeric layer backed by an adhesive layer comprising an adhesive material defining one of said major surfaces, with the other of said major surfaces having a surface texture that exhibits a 60 degree Gloss Level of less than or equal to about 15, said adhesive comprising a pressure sensitive adhesive, and said adhesive having rheological properties that allow said adhesive to achieve a wet out of at least about 70%, when said adhesive layer is applied onto a rough surface having a surface roughness with a peak count of at least 250 peaks/meter,
wherein the rheological properties exhibited by said adhesive include a Loss Tangent Delta value of (a) greater than or equal to about 0.65, when measured by a dynamic shear modulus at 1 radian/sec and 23 degrees C., (b) greater than or equal to about 0.40, when measured by a dynamic shear modulus at 0.1 radian/sec and 23 degrees C., or a combination of both (a) and (b).

2. The surface protection film according to claim 1, wherein said adhesive has rheological properties that allow said adhesive to achieve a wet out of at least about 85%, when said adhesive is applied onto a rough surface having a surface roughness with a peak count of at least 250 peaks/meter.

3. The surface protection film according to claim 1, wherein said adhesive has rheological properties that allow said adhesive to achieve the wet out, when said adhesive layer is applied onto a rough surface having a surface roughness with a peak count of up to about 950 peaks/meter.

4. The surface protection film according to claim 1, wherein said adhesive has rheological properties that allow said adhesive to achieve the wet out, when said adhesive layer is applied onto a rough surface having an average surface roughness (Ra) of less than about 13 μm.

5. The surface protection film according to claim 1, wherein said adhesive has rheological properties that allow said adhesive to achieve the wet out, when said adhesive layer is applied onto a rough surface having a maximum peak to valley height (Rt) of less than about 200 μm.

6. The surface protection film according to claim 1, wherein the rheological properties exhibited by said adhesive include a Loss Tangent Delta value, as measured by dynamic shear modulus at 1 radian/sec and 23 degrees C., of greater than or equal to about 0.70.

7. The surface protection film according to claim 1, wherein the rheological properties exhibited by said adhesive include a Loss Tangent Delta value, as measured by dynamic shear modulus at 0.1 radian/sec and 23 degrees C., of greater than or equal to about 0.50.

8. The surface protection film according to claim 1, wherein the rheological properties exhibited by said adhesive include a stress relaxation ratio, according to the equation: G′(t₂)/G′(t₁), of (a) less than or equal to about 0.1, when t₂ is 500 seconds and t₁ is 0.1 seconds, (b) less than or equal to 0.25, when t₂ is 500 seconds and t₁ is 1.0 seconds, or (c) a combination of both (a) and (b).

9. The surface protection film according to claim 1, wherein said surface protection film further comprises a clearcoat layer that is at least partially crosslinked and defines the other of said major surfaces having the surface texture.

10. The surface protection film according to claim 1, wherein said adhesive layer has a thickness that is at least about 76 μm (3.0 mils).

11. A combination comprising:
a substrate comprising a rough surface having a surface roughness with a peak count of at least 250 peaks/meter; and
said surface protection film according to claim 1,
wherein said adhesive layer is adhesively bonded to said substrate such that said surface protection film covers at least a portion of said rough surface.

12. The combination according to claim 11, wherein the substrate is selected from an architectural door, wall, railings, floor trim, wall trim, and vertical portion of a step.

13. The combination according to claim 11, wherein said rough surface has a surface roughness with a peak count (PC) of at least 400 peaks/meter.

14. The combination according to claim 11, wherein said rough surface has an average surface roughness (Ra) of less than about 12 μm.

15. The combination according to claim 11, wherein said rough surface has a maximum peak to valley height (Rt) of less than about 170 μm.

16. The combination according to claim 11, wherein said adhesive has rheological properties that allow said adhesive to achieve a wet out of at least about 85%.

17. The combination according to claim 11, wherein said rough surface has at least one of (a) a surface roughness with a peak count of up to about 950 peaks/meter, (b) an average surface roughness (Ra) of less than about 13 μm, and (c) a maximum peak to valley height (Rt) of less than about 200 μm; and said adhesive has rheological properties that allow said adhesive to achieve the wet out, when said adhesive layer is applied onto said rough surface.

18. The combination according to claim 17, wherein the rheological properties exhibited by said adhesive include at least one of (1) a Loss Tangent Delta value, as measured by dynamic shear modulus at 1 radian/sec and 23 degrees C., of greater than or equal to about 0.70, (2) a Loss Tangent Delta value, as measured by dynamic shear modulus at 0.1 radian/sec and 23 degrees C., of greater than or equal to about 0.50, and (3) a stress relaxation ratio, according to the equation: G′(t₂)/G′(t₁), of (a) less than or equal to about 0.1, when t₂ is 500 seconds and t₁ is 0.1 seconds, (b) less than or equal to 0.25, when t₂ is 500 seconds and t₁ is 1.0 seconds, or (c) a combination of both (a) and (b).

19. The combination according to claim 11, wherein said surface protection film further comprises a clearcoat layer that is at least partially crosslinked and defines the other of said major surfaces having the surface texture.

20. The combination according to claim 11, wherein said adhesive layer has a thickness that is at least about 76 μm (3.0 mils).
